(19) United States
(12) Patent Application Publication
(10) Pub. No.: US 2021/0133831 A1
(43) Pub. Date: May 6, 2021

(54) RULE ENCODING

(71) Applicant: eBay Inc., San Jose, CA (US)

(72) Inventors: Jonathan Paul BAGGOTT, Castro Valley, CA (US); Andrews PUNNOOSE, San Jose, CA (US); Francisco Jose CLAUDE FAUST, San Jose, CA (US)

(21) Appl. No.: 16/668,244

(22) Filed: Oct. 30, 2019

(51) Int. Cl. G06Q 30/02; G06F 16/22; G06F 16/21; G06F 16/25; G06Q 10/08

(52) U.S. Cl. CPC G06Q 30/0283; G06F 16/2246; G06Q 10/08345; G06F 16/252; G06F 16/212

(57) ABSTRACT

The disclosed technologies include receiving a selection of an item for which an attribute is to be determined. The attribute is dependent on one or more variable conditions. Data is input that represents a set of rules for determining the attribute. Based on the rules, a parse tree is generated that is usable to determine the attribute based on the one or more variable conditions. The data is parsed and nodes of the parse tree are pre-calculated as values become available. The attribute is determined based on the parsing and pre-calculating. The determined attribute is returned to a requesting process.

### BACKGROUND

Many systems require the implementation of rules to determine one or more parameters. For example, in an e-commerce system, when determining a final price for an electronic transaction, it must be determined whether a sales tax is applicable. If it is determined that a sales tax is applicable, and the correct sales tax must be calculated for a particular product and based on the correct rules for the governing jurisdiction. Other tasks in an e-commerce setting similarly require the implementation of rules. For example, rules can be used to categorize inventory, and determine and calculate shipping charges.

It is with respect to these and other technical considerations that the disclosure made herein is presented.

### SUMMARY

The determination of values in a system can be dependent upon a number of variables. For example, sales tax is typically based on a number of factors. These factors may include the geographic location of the buyer, the geographic location of the seller, the type and price of the item, and other factors. However, these factors typically change over the course of time. Correct determination of such values depends on updating the system as applicable rules change and are updated. However, the manual updating of systems and software to update the rules can be costly and time-consuming. This can be a particular challenge in the e-commerce context as such rules can change at variable and unpredictable times. For example, shipping carriers and shipping costs may change rapidly, and rules that impact the calculation of taxes may change locally or globally. If the system is not able to respond rapidly to such varied and unpredictable changes, the system may return inaccurate results.

When the tax rules are written into the software for an electronic transaction system, the encoding of the rules into software can be complex due to the large number of dependencies and conditions for correctly calculating the tax in a given situation. Furthermore, tax rules are frequently updated, which necessitates frequent software updates. The effort and delay required to update systems and software due to changes in rules as described above may have a number of detrimental effects. For example, users may be charged an incorrect tax amount or shipping charge if the system is not updated in a timely manner. Additionally, the effort and cost to update software may be a continuous drain on resources. From a resource standpoint, processing updates and troubleshooting incompatibilities may unnecessarily consume computing, storage, and network resources.

The present disclosure provides a way to encode such rules using a standardized format that enables the rules to be encoded and updated independently from the software. The rules (such as tax rules and shipping rules) may be represented as a parse tree, where each node is either an operation or a value. The parse tree can be encoded using a language-independent format such as JavaScript Object Notation (JSON), which can be read by a number of languages without having to develop a parser. The disclosed techniques can be used for any type of rules that have a number of dependencies that are subject to change.

The disclosed technologies address the technical problems presented above, and potentially others, by enabling an e-commerce system to quickly adapt to new tax rules, shipping models, and other rule-based mechanisms. The disclosed technologies also allow for reduction of the amount of code variations, thus reducing the waste of computing resources (e.g., amount of memory or number of processor cycles required to maintain all combinations of configurations). Other technical benefits not specifically mentioned herein can also be realized through implementations of the disclosed technologies.

It should be appreciated that the subject matter described above and in further detail below can be implemented as a computer-controlled apparatus, a computer-implemented method, a computing device, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying FIGS. In the FIGS., the left-most digit(s) of a reference number identifies the FIG. in which the reference number first appears. The same reference numbers in different FIGS. indicate similar or identical items.

FIG. 1 is a system diagram illustrating one embodiment disclosed herein;

FIG. 2 is a diagram showing aspects of an example system according to one embodiment disclosed herein;

FIG. 3 is a diagram showing an example user system according to one embodiment disclosed herein;

FIG. 4A is a diagram illustrating an example tree as disclosed herein;

FIG. 4B is a diagram illustrating an example tree as disclosed herein;

FIG. 5 is a flow diagram showing aspects of an illustrative routine, according to one embodiment disclosed herein;

FIG. 6 is a flow diagram showing aspects of an illustrative routine, according to one embodiment disclosed herein;

FIG. 7 is a computer architecture diagram illustrating aspects of an example computer architecture for a computer capable of executing the software components described herein.

FIG. 8 is a data architecture diagram showing an illustrative example of a computing environment.

### DETAILED DESCRIPTION

In various embodiments, the following Detailed Description presents technologies for encoding rules using a standardized format that enables the rules to be updated independently from application software. The disclosure thus defines a framework for encoding rules that is independent of specific programming languages. It is to be appreciated that while the technologies disclosed herein are primarily described in the context of online e-commerce systems, the technologies described herein can be utilized to encode rules in other contexts, which will be apparent to those of skill in the art. The techniques disclosed herein can improve user interaction with a computing device, which can increase productivity and help reduce the number of inadvertent, obsolete, or otherwise incorrect inputs. Also, by providing more accurate and efficient encoding of rules, a system can operate more efficiently with respect to the use of memory, processing resources, network resources, etc.

The determination of values in an e-commerce system can be dependent upon a number of variables. For example, the calculation of sales tax is typically based on a number of factors. These factors may include the geographic location of the buyer, the geographic location of the seller, the type of item, the current state and local tax rules, as well as other factors. However, these factors typically change over the course of time. Correct determination of such values depends on updating the system as the rules change and are updated. However, the manual updating of systems and software to update the rules can be costly and time-consuming. This can be a particular challenge in the e-commerce context as such rules can change at variable and unpredictable times. For example, rules that impact the calculation of taxes may change locally or globally on an annual basis or even more frequently. If the system is not able to respond rapidly to such varied and unpredictable changes, the system may return inaccurate results.

When rules such as tax rules and shipping cost rules are written into the software for an electronic transaction system, the encoding of the rules into software can be complex due to the large number of dependencies and conditions for correctly calculating the values in a given situation. Furthermore, tax and other rules are frequently updated, which necessitates frequent software updates. The effort and delay required to update systems and software due to changes in rules as described above may have a number of detrimental effects. For example, users may be charged an incorrect tax amount or shipping charge if the system is not updated in a timely manner. Additionally, the effort and cost to update software may be a continuous drain on resources. From a resource standpoint, processing updates and troubleshooting incompatibilities may unnecessarily consume computing, storage, and network resources.

The present disclosure provides a way to encode such rules using a standardized format that enables the rules to be encoded and updated independently from the software. The rules (such as tax rules and shipping rules) may be represented as a parse tree, where each node is either an operation or a value. The parse tree can be encoded using a language-independent format such as JavaScript Object Notation (JSON), which can be read by a number of languages without having to develop a parser. The disclosed techniques can be used for any type of rules that have a number of dependencies such as calculation of shipping costs.

Referring to the appended drawings, in which like numerals represent like elements throughout the several FIGURES, aspects of various technologies for encoding rules will be described. In the following detailed description, references are made to the accompanying drawings that form a part hereof, and which are shown by way of illustration specific configurations or examples.

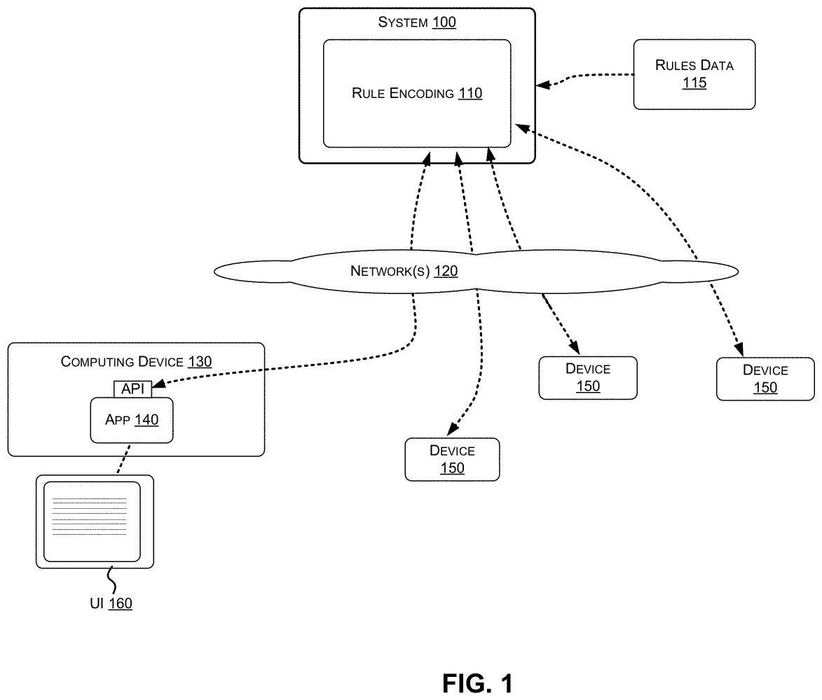

In the example system illustrated in FIG. 1, a system 100 is illustrated that implements rules encoding function 110. The rules encoding function 110 may be configured to calculate one or more values based on rules data 115 and provide the values to various devices 150 over a network 120, as well as computing device 130. A user interface 160 may be rendered on computing device 130. The user interface 160 may be provided in conjunction with an application 140 that communicates to the system 100 using an API via network 120. In some embodiments, system 100 may be configured to provide e-commerce services to users. In one example, rules encoding function 110 may be configured to calculate values based on rules data 115, such as sales tax or shipping costs, and provide the results to computing device 130 and various devices 150.

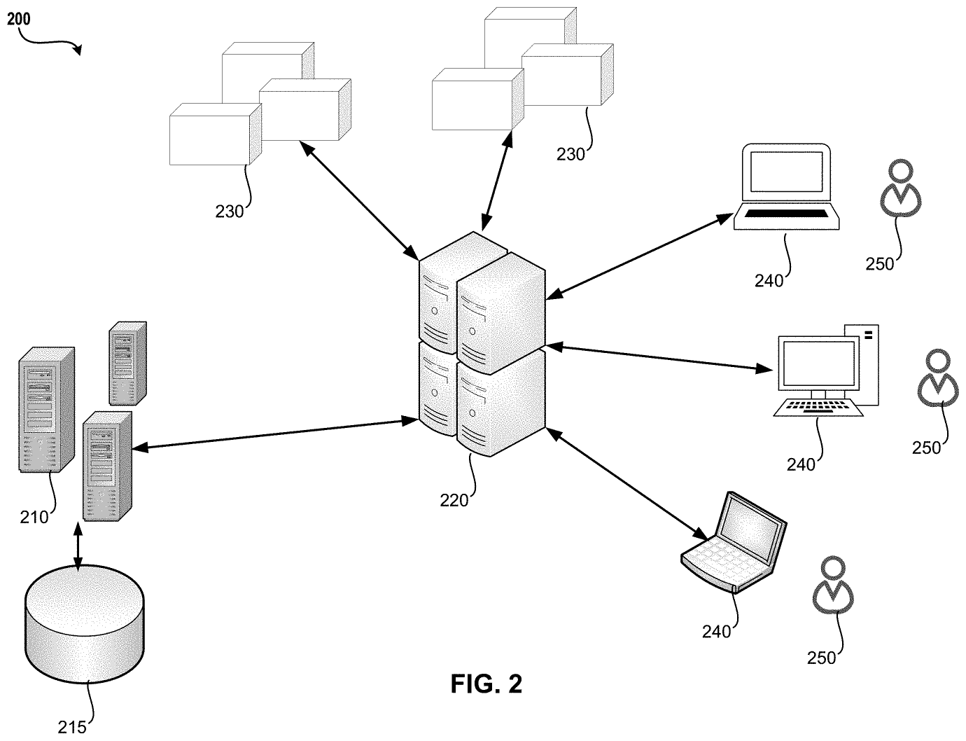

FIG. 2 illustrates a block diagram showing an example environment where a platform such as e-commerce platform 110 may be implemented. FIG. 2 illustrates an e-commerce environment 200 that may include servers 210. The servers 210 may comprise one or more servers, which may collectively referred to as “server.” The e-commerce environment 200 may further include a database 215, which may be configured to store various information used by the server 210 including product data, user data, rules data, and the like. The e-commerce environment 200 may further include communications server 220, which, for example, enables network communication between the server 210, online servers 230, and client devices 240. The client devices 240 may be any type of computing device that may be used by users 250 to connect with the server 210 over a communications network. Users 250 may be, for example, users who are accessing services provided by communications server 220 and/or online servers 230. The servers 230 may be operated by any party that is involved in providing, for example, online services. For example, the servers 230 may be configured to implement auction sites or online transactions. Accordingly, the servers 230 may be any type of computing device described herein as may be operated by an auction broker, a financial institution, and the like. The servers and devices represented in FIG. 2 communicate via various network communications hardware and software to facilitate the collection and exchange of data for use in a networked environment.

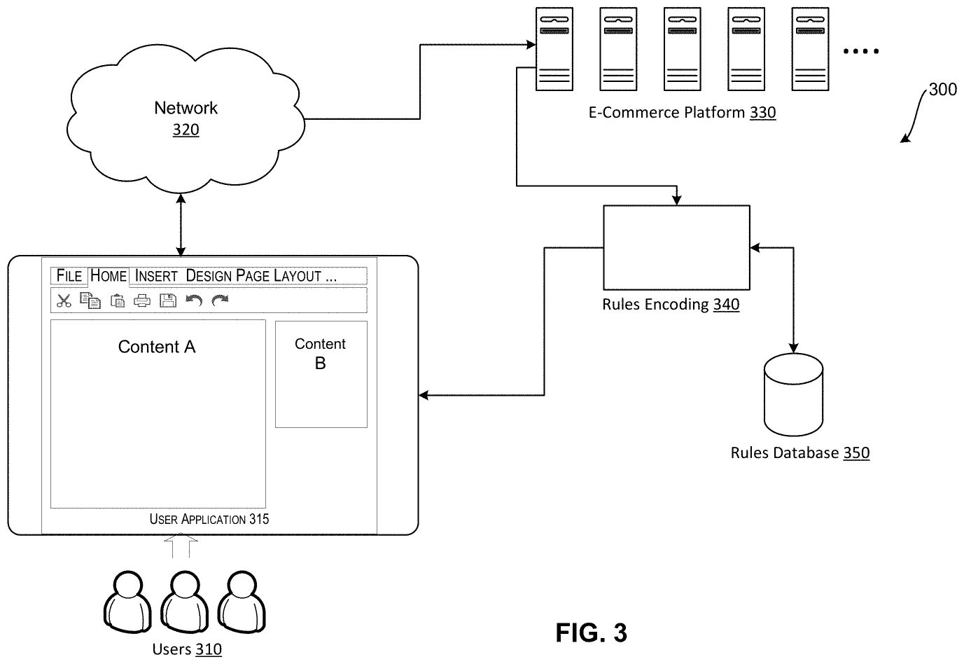

FIG. 3 is a computing system architecture diagram showing an overview of a system disclosed herein for implementing a rules-based encoding technique, according to one embodiment disclosed herein. As shown in FIG. 3, an e-commerce system 300 may be configured to perform product fulfillment and value calculations, or other functions based upon various data collected by and processed by data analysis components of an e-commerce platform 330. The e-commerce platform 330 may, for example, include, but are not limited to, physical computing devices such as server computers or other types of hosts, associated hardware components (e.g. memory and mass storage devices), and networking components (e.g. routers, switches, and cables). The e-commerce platform 330 can also include software, such as operating systems, applications, and containers, network services, virtual components, such as virtual disks, virtual networks, and virtual machines. The e-commerce platform 330 may communicate with or implement a rules encoding function 340 that is configured to access a rules database 350. The rules database 350 can include data, such as a database, or a database shard (i.e. a partition of a database), and may store various rules for determining sales tax, shipping costs, and the like. Data may be provided to the user application 315 to provide results to various users 310 using a user application 315. A query function may be used to query the rules database 340 for the latest rules information.

In some embodiments, a rules-based encoding system may define a restricted set of primitives that can express all rules required for calculating a desired value. For example, a set of primitives may be defined for determining the sales tax for a given region such as a state within the U.S. Sales taxes may be associated with various geographic or geo-political areas. In one embodiment, the rules may be encoded to provide a language-agnostic description of taxes, standardize and centralize the description of tax rules for items in the e-commerce environment, and support the partial evaluation of tax rules to pre-compute values as needed to accommodate different service-level agreements (SLAs) and information availability. Additionally, it would be desirable that the encoded rules are readily read by a machine without having to build a parser.

In an embodiment, the rules may be represented using JSON. In some embodiments, formulas may be represented as a parse tree. This may allow for efficient evaluation as a recursive function. For example, this alleviates the need to support parenthesis in the formulas, as parentheses may be inferred from the structure of the parse tree. In one embodiment, a parse tree for a formula may be generated as follows:

Each node is either an operation or a value;

Values are either constants or variables;

The operations are +, −, *, /.

The formulas may be analyzed to list all variables needed to determine its value. The formulas can be partially evaluated with the values known at a point in time. This makes it possible to evaluate known values at a given stage, and pass on the partially evaluated formula to later stages in any process. One example where this is desirable is indexing and query serving. At indexing time, the location of an item, and certain values may be known, but the buyer's location may not be known, for example. The known values can be used to populate the parse tree and the final calculation(s) may be performed once the buyer's location is known.

If the numbers are integers, then the results of division operations may be rounded. The default rounding may be to the closest integer, but this can be changed by adding an extra parameter to division operations.

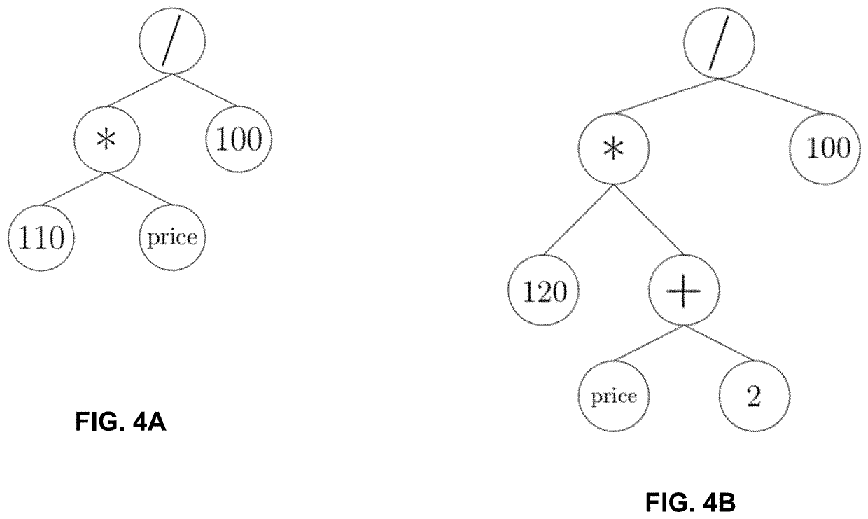

In one example illustrated in FIG. 4A, the price formula for an example tax calculation is:

110×price/100

The node containing the multiplication (*) is an operation node. The node containing “110” is a value node containing a constant, and the node with the label “price” is a value node containing a variable.

The example illustrated in FIG. 4B shows why parentheses are not needed. FIG. 4B illustrates a parse tree implementing the formula:

120×(price+2)/100.

When mapping to JSON, each node may be mapped to an object, and the type of the node can be an operation (+, −, *, /), a constant, or a variable. Each type may have a defined set of properties. For operations, the properties may be arg1 and arg2. For constants, the property may be the value, and for variables the property may be the variable name.

For the example illustrated in FIG. 4B, the formula shown may be mapped to the following JSON representation:

{

″type″: ″/″,
“rounding”: “nearest_integer”
″arg1″: {

″type″: “*”,
″arg1″: {

″type″: ″constant″,
″value″: 120

},
″arg2″: {

″type″: ″+″,
″arg1″: {

″type″: ″variable″,
″name″: ″price″

},
″arg2″: {

″type″: ″constant″,
″value″: 2

}

}

},
″arg2″: {

″type″: ″constant″,
″value″: 100

}

}

For conditions, Boolean formulas can be defined in a similar fashion as the numeric formulas. For Boolean formulas we have the following operators:

Comparison: <, <=, ==, >=, >.

Inclusion: whether a value belongs to a set.

Conjunctive (AND) and disjunctive (OR) Boolean formulas.

The fan-out can be greater than 2, which means that a node can have an arbitrary number of children.

Negation (NOT), where the nodes have only one child.

An example of a comparison in the tax calculation scenario is if it is to be determined if the price is less or equal than a predetermined value. In this example, the condition may be price_usd<1000*USD_to_location. The second set of Boolean operators can be used, for example, in cases where the location is restricted, for example buyer_location in {‘location’}.

In this example, the conditions that need to be met are:

1. Buyer in ‘location’

2. Item outside ‘location’

3. Price in ‘location’ less than 1000

4. Item not in certain categories

All four conditions need to be valid, so each can be written separately and then shown how they are represented in conjunction.

Condition 1

Restrict the buyer location (a variable) to be in ‘location’:

{

“type”: “inclusion”,
“set”: [

{

“type”: “value”,
“value”: “LOCATION”

}

],
“item”: {

“type”: “variable”,
“name”: “item_location”

}

}

Condition 2

The item is restricted to be outside of ‘location.’

{

“type”: “not”,
“condition”: {

“type”: “inclusion”,
“set”: [

{

“type”: “constant”,
“value”: “LOCATION”

}

],
“item”: {

“type”: “variable”,
“name”: “item_location”

}

}

}

Condition 3

The price in local currency should not exceed 1,000.

{

“type”: “<=”,
“arg1”: {

“type”: “/”,
“rounding”: “nearest_integer”,
“arg1”: {

“type”: “*”,
“arg1”: {

“type”: “variable”,
“name”: “price_usd”

},
“arg2”: {

“type”: “variable”,
“name”: “conversion_usd_location”

}

},
“arg2”: {

“type”: “constant”,
“value”: 100

}

},
“arg2”: {

“type”: “constant”,
“value”: 1000

}

}

Condition 4

The item does not belong to an exception category (e.g., the IDs are 2, 5, and 9).

{

“type”: “not”,
“condition”: {

“type”: “inclusion”,
“set”: [

{

“type”: “constant”,
“value”: 2

},
{

“type”: “constant”,
“value”: 5

},
{

“type”: “constant”,
“value”: 9

}

],
“item”: {

“type”: “variable”,
“name”: “item_category”

}

}

}

Combining all Conditions

All conditions can be combined with an AND operation as follows:

{

“type”: “and”,
“conditions”: [

C1,
C2,
C3,
C4

]

}

Where C1, C2, C3, and C4 are the JSON specification of the conditions 1 to 4.

In an embodiment, a data package may be generated that contains tax rules as a set of JSON files. In one embodiment, each file of the data package may specify the use case name, the condition under which the tax applies, and the formulas for how price and shipping are calculated for the tax. The package may also list the variables that the tax rule uses. The list of variables can be inferred, but this redundancy may be added to detect potential typographical errors using static analysis on the specification. Such errors may be more difficult to catch at runtime.

The following provides one example of specification of a sales tax set of rules:

{

“name”: “Country_GST”,
“variables”: [

“price”,

“shipping_price”,

“price_usd”,
“buyer_location”,
“item_location”,
“conversion_usd_aud”,
“item_category”

],
“formulas”: {

“price_with_taxes”: {

“type”: “round”,
“arg”: {

“type”: “/”,
“rounding”: “nearest_integer”,
“arg1”: {

“type”: “*”,
“arg1”: {

“type”: “value”,
“value”: 110

},
“arg2”: {

“type”: “variable”,
“name”: “price”

}

}

},

“arg2”: {

“type”: “constant”,
“value”: 100

}

},
“shipping_with_taxes”: {

“type”: “round”,
“arg”: {

“type”: “/”,
“rounding”: “nearest_integer”,
“arg1”: {

“type”: “*”,
“arg1”: {

“type”: “value”,
“value”: 110

},
“arg2”: {

“type”: “variable”,
“name”: “price”

}

}

},
“arg2”: {

“type”: “constant”,
“value”: 100

}

}

},
“condition”: {

“type”: “and”,
“conditions”: [

{

“type”: “inclusion”,
“set”: [

{

“type”: “value”,
“value”: “AU”

}

],
“item”: {

“type”: “variable”,
“name”: “buyer_location”

}

}, {

“type”: “not”,
“condition”: {

“type”: “inclusion”,
“set”: [

{

“type”: “constant”,
“value”: “COUNTRY”

}

],
“item”: {

“type”: “variable”,
“name”: “item_location”

}

}

}, {

“type”: “<=”,
“arg1”: {

“type”: “/”,
“rounding”: “nearest_integer”,
“arg1”: {

“type”: “*”,
“arg1”: {

“type”: “variable”,
“name”: “price_usd”

},

“arg2”: {

“type”: “variable”,

“name”: “conversion_usd_LOCAL”
}

},
“arg2”: {

“type”: “constant”,
“value”: 100

}

},
“arg2”: {

“type”: “constant”,
“value”: 1000

}

}, {

“type”: “not”,
“condition”: {

“type”: “inclusion”,
“set”: [

{

“type”: “constant”,
“value”: 2

},
{

“type”: “constant”,
“value”: 5

},
{

“type”: “constant”,
“value”: 9

}

],
“item”: {

“type”: “variable”,
“name”: “item_category”

}

}

}

]

}

}

In some embodiments, indexing can run every element through the set of rules. A table of taxes can be built with generated IDs that are stable across updates, and the rules can be used to determine which tax rules apply to each item.

Each item may have a multi-value attribute that contains the tax IDs that apply. Each tax ID may be mapped to a description in the index properties that contains the following information:

| | |
|---|---|
| TAX_ID | ID for this tax (stable) |
| LOCATIONS | Buyer locations where it applies |
| PRICE_THRESHOLD | Price threshold for which this tax applies |
| PERC_PRICE | Percentage of tax applied to the price |
| PERC_SHIPPING | Percentage of tax applied to the shipping |

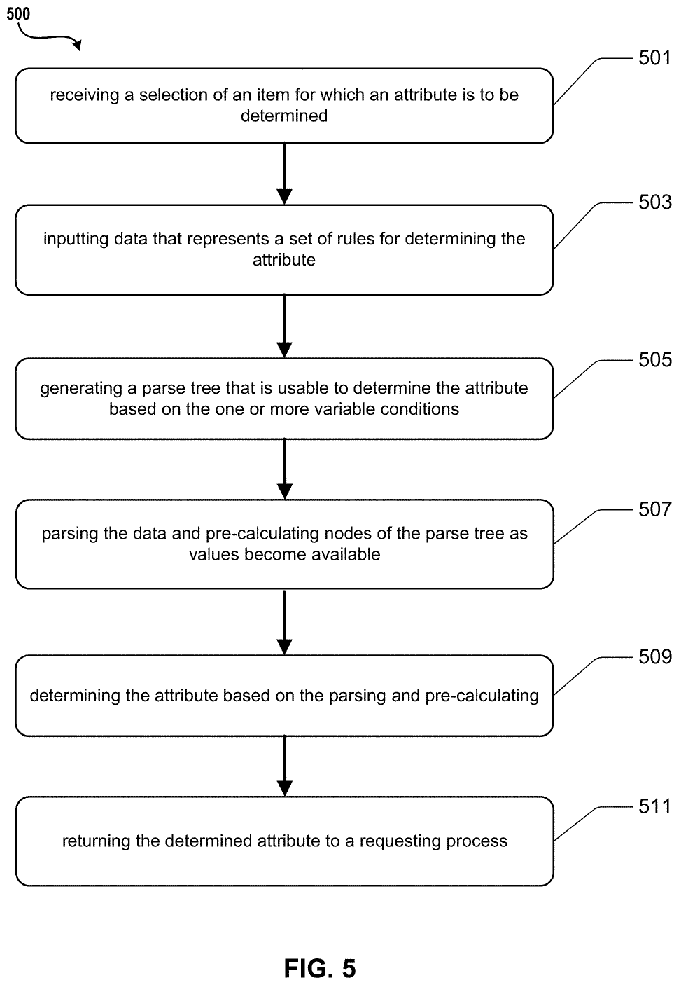

FIG. 5 is a diagram illustrating aspects of a routine 500 for implementing some of the techniques disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

The routine 500 begins at operation 501, which illustrates receiving a selection of an item. In an embodiment, the item has a plurality of selectable configurations return the determined attribute to a requesting process.

The routine 500 then proceeds to operation 503, which illustrates inputting data that represents a set of rules for determining the attribute. Operation 505 illustrates based on the rules, generating a parse tree that is usable to determine the attribute based on the one or more variable conditions. Next, operation 507 illustrates parsing the data and pre-calculating nodes of the parse tree as values become available. Operation 509 illustrates determining the attribute based on the parsing and pre-calculating. Operation 511 illustrates returning the determined attribute to a requesting process.

In an embodiment, the rules are in a language-independent data format. The language-independent data format may allow for the rules to be written so that software written in multiple languages can read and execute the rules. In one embodiment, the language-independent data format may be JSON. In an embodiment, the parsing may be performed in an application processing space during executing of a program. In an embodiment, the parsing may be performed without updating software executing in the application processing space.

In an embodiment, the data may be input via an application programming interface (API) configured to receive the data and returns the determined attribute to the requesting process.

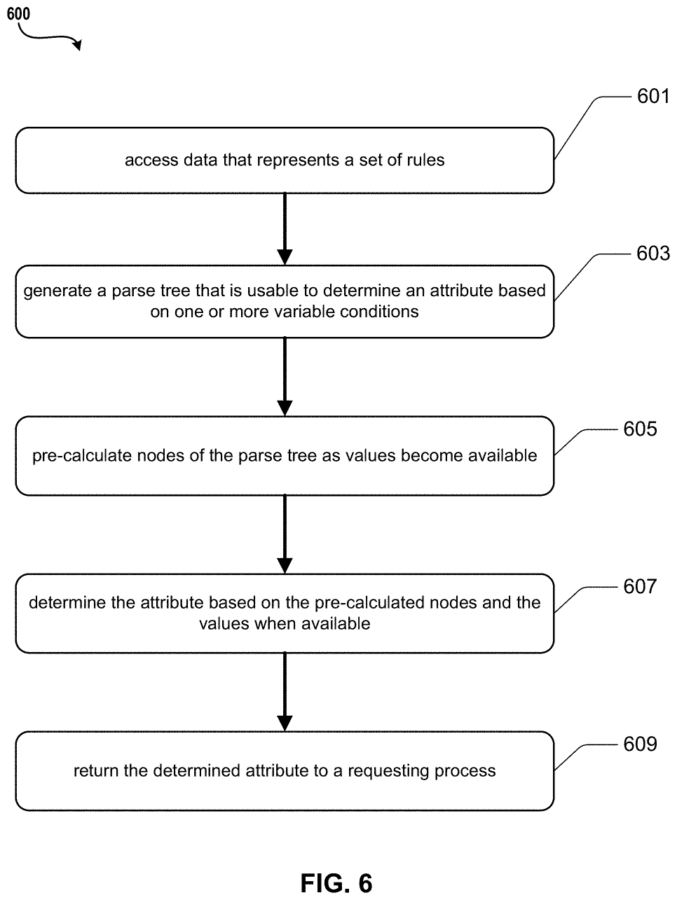

FIG. 6 is a diagram illustrating aspects of a routine 600 for implementing some of the techniques disclosed herein.

The routine 600 begins at operation 601, which illustrates accessing data that represents a set of rules. The routine 600 then proceeds to operation 603, which illustrates based on the rules, generating a parse tree that is usable to determine an attribute based on one or more variable conditions. Operation 605 illustrates pre-calculating nodes of the parse tree as values become available. Operation 607 illustrates determining the attribute based on the pre-calculated nodes and the values when available. Operation 609 illustrates returning the determined attribute to a requesting process.

The attribute may be a parameter that is to be calculated based on one or more dependent factors such as location or date. In an embodiment, the attribute may be a sales tax. In another embodiment, the attribute may be a shipping cost. In an embodiment, the sales tax may be for a geographic or geo-political entity.

The parse tree may enable a number of features that can be inferred without explicit expression. In an embodiment, parentheses may be inferred from a structure of the parse tree. In an embodiment, each node of the parse tree may be either an operation or a value. For example, the operations may be one of +, −, *, or /. In an embodiment, the values may be one of constants or variables.

In an embodiment, the pre-calculating may comprise partially evaluating formulas with known values and passing the partially evaluated formula to later stages.

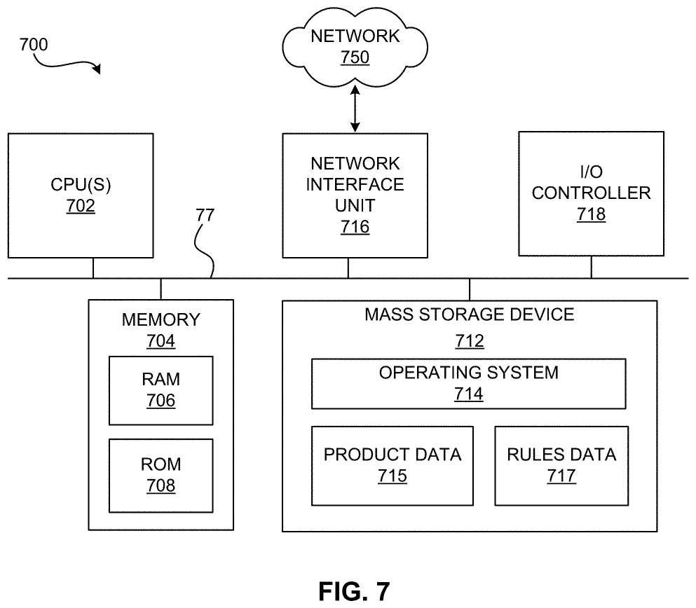

FIG. 7 shows an example computer architecture for a computer capable of providing the functionality described herein such as, for example, a computing device configured to implement the functionality described above with reference to FIGS. 1-6. Thus, the computer architecture 700 illustrated in FIG. 7 illustrates an architecture for a server computer or another type of computing device suitable for implementing the functionality described herein. The computer architecture 700 might be utilized to execute the various software components presented herein to implement the disclosed technologies.

The computer architecture 700 illustrated in FIG. 7 includes a central processing unit 702 (“CPU”), a system memory 704, including a random-access memory 706 (“RAM”) and a read-only memory (“ROM”) 708, and a system bus 77 that couples the memory 704 to the CPU 702. A firmware containing basic routines that help to transfer information between elements within the computer architecture 700, such as during startup, is stored in the ROM 708. The computer architecture 700 further includes a mass storage device 712 for storing an operating system 714, other data, and one or more executable programs, such as storing product data 715 or storing rules data 717.

The mass storage device 712 is connected to the CPU 702 through a mass storage controller (not shown) connected to the bus 77. The mass storage device 712 and its associated computer-readable media provide non-volatile storage for the computer architecture 700. Although the description of computer-readable media contained herein refers to a mass storage device, such as a solid-state drive, a hard disk or optical drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

By way of example, and not limitation, computer-readable storage media might include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes of the claims, the phrase “computer storage medium,” “computer-readable storage medium” and variations thereof, does not include waves, signals, and/or other transitory and/or intangible communication media, per se.

According to various implementations, the computer architecture 700 might operate in a networked environment using logical connections to remote computers through a network 750 and/or another network (not shown). A computing device implementing the computer architecture 700 might connect to the network 750 through a network interface unit 716 connected to the bus 77. It should be appreciated that the network interface unit 716 might also be utilized to connect to other types of networks and remote computer systems.

The computer architecture 700 might also include an input/output controller 718 for receiving and processing input from a number of other devices, including a keyboard, mouse, or electronic stylus (not shown in FIG. 7). Similarly, the input/output controller 718 might provide output to a display screen, a printer, or other type of output device (also not shown in FIG. 7).

It should be appreciated that the software components described herein might, when loaded into the CPU 702 and executed, transform the CPU 702 and the overall computer architecture 700 from a general-purpose computing system into a special-purpose computing system customized to facilitate the functionality presented herein. The CPU 702 might be constructed from any number of transistors or other discrete circuit elements, which might individually or collectively assume any number of states. More specifically, the CPU 702 might operate as a finite-state machine, in response to executable instructions contained within the software modules disclosed herein. These computer-executable instructions might transform the CPU 702 by specifying how the CPU 702 transitions between states, thereby transforming the transistors or other discrete hardware elements constituting the CPU 702.

Encoding the software modules presented herein might also transform the physical structure of the computer-readable media presented herein. The specific transformation of physical structure might depend on various factors, in different implementations of this description. Examples of such factors might include, but are not limited to, the technology used to implement the computer-readable media, whether the computer-readable media is characterized as primary or secondary storage, and the like. If the computer-readable media is implemented as semiconductor-based memory, the software disclosed herein might be encoded on the computer-readable media by transforming the physical state of the semiconductor memory. For example, the software might transform the state of transistors, capacitors, or other discrete circuit elements constituting the semiconductor memory. The software might also transform the physical state of such components in order to store data thereupon.

As another example, the computer-readable media disclosed herein might be implemented using magnetic or optical technology. In such implementations, the software presented herein might transform the physical state of magnetic or optical media, when the software is encoded therein. These transformations might include altering the magnetic characteristics of locations within given magnetic media. These transformations might also include altering the physical features or characteristics of locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 might include other types of computing devices, including hand-held computers, embedded computer systems, personal digital assistants, and other types of computing devices known to those skilled in the art.

It is also contemplated that the computer architecture 700 might not include all of the components shown in FIG. 7, might include other components that are not explicitly shown in FIG. 7, or might utilize an architecture completely different than that shown in FIG. 7. For example, and without limitation, the technologies disclosed herein can be utilized with multiple CPUS for improved performance through parallelization, graphics processing units (“GPUs”) for faster computation, and/or tensor processing units (“TPUs”). The term “processor” as used herein encompasses CPUs, GPUs, TPUs, and other types of processors.

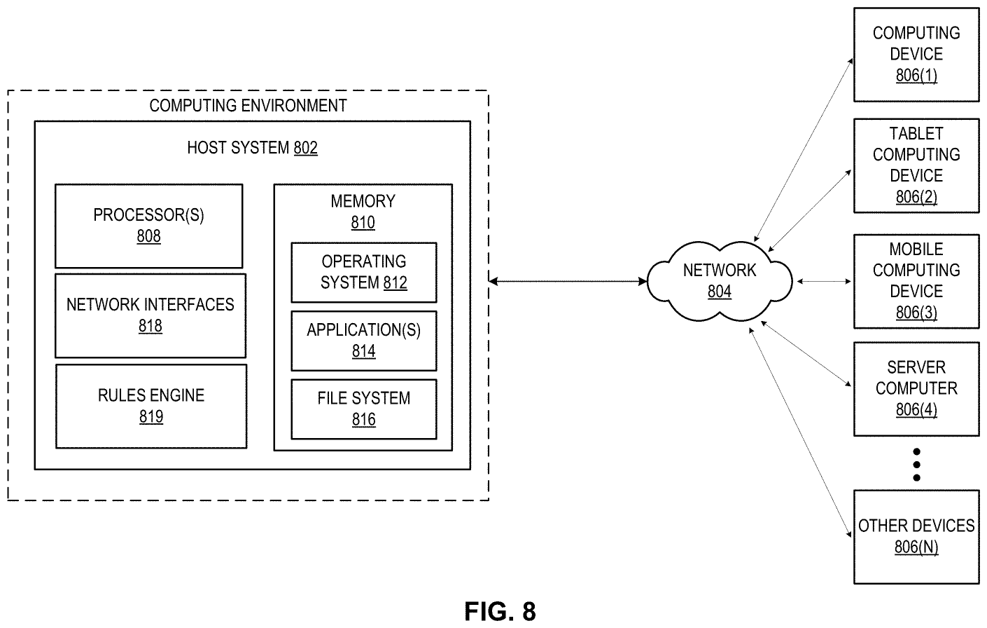

FIG. 8 illustrates an example computing environment capable of executing the techniques and processes described above with respect to FIGS. 1-7. In various examples, the computing environment comprises a host system 802. In various examples, the host system 802 operates on, in communication with, or as part of a network 804.

The network 804 can be or can include various access networks. For example, one or more client devices 806(1) . . . 806(N) can communicate with the host system 802 via the network 804 and/or other connections. The host system 802 and/or client devices can include, but are not limited to, any one of a variety of devices, including portable devices or stationary devices such as a server computer, a smart phone, a mobile phone, a personal digital assistant (PDA), an electronic book device, a laptop computer, a desktop computer, a tablet computer, a portable computer, a gaming console, a personal media player device, or any other electronic device.

According to various implementations, the functionality of the host system 802 can be provided by one or more servers that are executing as part of, or in communication with, the network 804. A server can host various services, virtual machines, portals, and/or other resources. For example, a can host or provide access to one or more portals, Web sites, and/or other information.

The host system 802 can include processor(s) 808 and memory 810. The memory 810 can comprise an operating system 812, application(s) 814, and/or a file system 816. Moreover, the memory 810 can comprise the storage unit(s) 82 described above with respect to FIGS. 1-7.

The processor(s) 808 can be a single processing unit or a number of units, each of which could include multiple different processing units. The processor(s) can include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory 810.

The memory 810 can include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PCM), static random-access memory (SRAM), dynamic random-access memory (DRAM), other types of random-access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The host system 802 can communicate over the network 804 via network interfaces 818. The network interfaces 818 can include various types of network hardware and software for supporting communications between two or more devices. The host system 802 may also include rules engine 819, which may be configured to implement aspects of the functionality disclosed herein.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines are described herein as being implemented, at least in part, by an application, component, and/or circuit. Although the following illustration refers to the components of specified figures, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

In closing, although the various technologies presented herein have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for calculating rules-based values, the method comprising:
receiving a selection of an item for which an attribute is to be determined, wherein the attribute is dependent on one or more variable conditions;
inputting data that represents a set of rules for determining the attribute;
based on the rules, generating a parse tree that is usable to determine the attribute based on the one or more variable conditions;
parsing the data and pre-calculating nodes of the parse tree as values become available;
determining the attribute based on the parsing and pre-calculating; and
returning the determined attribute to a requesting process.

2. The method of claim 1, wherein the rules are in a language-independent data format.

3. The method of claim 2, wherein the language-independent data format is JSON.

4. The method of claim 1, wherein the parsing is performed in an application processing space.

5. The method of claim 1, wherein the attribute is a sales tax.

6. The method of claim 1, wherein the attribute is a shipping cost.

7. The method of claim 4, wherein the parsing is performed without updating software executing in the application processing space.

8. The method of claim 1, wherein the data is input via an application programming interface (API) configured to receive the data and returns the determined attribute to the requesting process.

9. A computing system, comprising:
one or more processors; and
a computer-readable storage medium having computer-executable instructions stored thereupon which, when executed by the processor, cause the processor to:
access data that represents a set of rules;
based on the rules, generate a parse tree that is usable to determine an attribute based on one or more variable conditions;
pre-calculate nodes of the parse tree as values become available;
determine the attribute based on the pre-calculated nodes and the values when available; and
return the determined attribute to a requesting process.

10. The computing system of claim 9, wherein the attribute is a sales tax.

11. The computing system of claim 10, wherein the sales tax is for a geographic or geo-political entity.

12. The computing system of claim 9, wherein parentheses are inferred from a structure of the parse tree.

13. The computing system of claim 9, wherein each node of the parse tree is either an operation or a value.

14. The computing system of claim 13, wherein the values are one of constants or variables.

15. The computing system of claim 13, wherein the operations are one of +, −, *, or /.

16. The computing system of claim 13, wherein the pre-calculating comprises partially evaluating formulas with known values and passing the partially evaluated formula to later stages.

17. A computer-readable storage medium having computer-executable instructions stored thereupon which, when executed by a processor of a computing device, cause the computing device to:
receiving a selection of an item for which an attribute is to be determined, wherein the attribute is dependent on one or more variable conditions;
retrieving data that represents a set of rules;
based on the set of rules, generating a parse tree that is usable to determine the attribute based on the one or more variable conditions;
parsing the data and pre-calculating nodes of the parse tree as values become available;
determining the attribute based on the parsing and pre-calculating; and
returning the determined attribute to a requesting process.

18. The computer-readable storage medium of claim 16, wherein the rules are implemented in JSON.

19. The computer-readable storage medium of claim 16, wherein the parsing is performed in an application processing space, and the parsing is performed without updating software executing in the application processing space.

20. The computer-readable storage medium of claim 16, wherein the attribute is a sales tax or a shipping cost.
